(19) United States
(12) Patent Application Publication
(10) Pub. No.: US 2016/0247473 A1
(43) Pub. Date: Aug. 25, 2016

(54) TRANSMISSION DEVICE, RECEPTION DEVICE, TRANSMISSION/RECEPTION SYSTEM, AND IMAGE DISPLAY SYSTEM

(71) Applicant: THINE ELECTRONICS, INC., Tokyo (JP)

(72) Inventors: Hiromichi MATSUDA, Chiyoda-ku (JP); Takatoshi UCHIDA, Tokyo (JP); Takayuki SUZUKI, Tokyo (JP)

(73) Assignee: THINE ELECTRONICS, INC., Tokyo (JP)

(21) Appl. No.: 15/026,669

(22) PCT Filed: Sep. 30, 2014
(86) PCT No.: PCT/JP2014/076161

§ 371 Date: Apr. 1, 2016

(30) Foreign Application Priority Data
Oct. 4, 2013 (JP) 2013-209354

(51) Int. Cl. G09G 3/36

(52) U.S. Cl. CPC G09G 3/3648; G09G 2310/08

(57) ABSTRACT

For serial data transmitted from a transmission device 10 to a reception device 20, a timing of transition from a first level to a second level is in each unit period. Image data serves as a first type of data for which two or more transitions from the second level to the first level are in each unit period. Control data serves as a second type of data for which one transition from the second level to the first level is in each unit period and the number of bits having the second level in each unit period corresponds to a control signal.

### CROSS REFERENCE TO RELATED APPLICATIONS

This application is a National Stage of International Application No. PCT/JP2014/076161 filed Sep. 30, 2014, claiming priority based on Japanese Patent Application No. 2013-209354 filed Oct. 4, 2013, the contents of all of which are incorporated herein by reference in their entirety.

### TECHNICAL FIELD

The present invention relates to a transmission device, a reception device, a transmission/reception system, and an image display system.

### BACKGROUND ART

An image display system such as a liquid crystal display system includes a transmission device, a reception device, and an image display device. A clock may be transmitted through a signal line separate from a signal line through which data is transmitted from the transmission device to the reception device or data in which the clock is embedded may be transmitted from the transmission device to the reception device (see Non Patent Literatures 1 and 2). For the data in which the clock is embedded, a timing of transition from a first level to a second level is in each unit period and information of a predetermined number of bits is provided in the unit period starting from the timing of transition. Also, one of the first and second levels is a high level and the other is a low level.

The transmission device inputs an image signal or the like from an outside and transmits image data and control data to the reception device. The reception device receives the image data and the control data from the transmission device, performs control on the basis of the control data, and transmits the image signal to the image display device. The image display device displays an image on the basis of the image signal transmitted from the reception device.

In an image display system such as a liquid crystal display system, generally, the above-described transmission device or a device including the transmission device is referred to as a “timing controller” and the above-described reception device or a device including the reception device is referred to as a “driver.” Also, generally, a plurality of drivers are connected to one timing controller.

In a transmission/reception system including a transmission device and a reception device which transmit and receive such image data, an active period in which the image data is transmitted and received and a blank period in which no image data is transmitted or received are provided. Control data indicating a control signal (control command) for controlling the reception device is transmitted from the transmission device to the reception device during the blank period.

### CITATION LIST

### Non Patent Literature

[Non Patent Literature 1] Jeong-Ho Kang, et al, “A Clock-embedded Voltage Differential Signaling (CVDS) for the Chip-On-Glass Application of TFT-LCD,” SID 10 DIGEST, pp. 66-69 (2010).
[Non Patent Literature 2] Dong Hoon Baek, et al, “Late-NewsPaper: The Enhanced Reduced Voltage Differential Signaling (eRVDS) Interface With Clock Embedded Scheme for Chip-On-Glass TFT-LCD Applications,” SID 10 DIGEST, pp. 70-73 (2010)

### SUMMARY OF INVENTION

### Technical Problem

In the conventional transmission/reception system, a timing at which the control data is transmitted from the transmission device to the reception device is fixed to a specific timing during the blank period. The reception device designates data received at the fixed timing as the control data. Due to this, there is a problem in that the degree of freedom of control data transmission from the transmission device to the reception device is low, and, for example, the timing at which the reception device requires the control command and the transmission timing are different from each other or it is difficult to increase types and the number of control commands.

The present invention has been made to solve the above-described problem and an objective of the invention is to provide a transmission device and a reception device for increasing the degree of freedom of control data transmission from the transmission device to the reception device. Also, an objective of the invention is to provide a transmission/reception system including the transmission device and the reception device and an image display system including the transmission device, the reception device, and an image display device.

### Solution to Problem

A transmission device of the present invention is a transmission device for transmitting serial data for which a timing of transition from a first level to a second level is in each unit period and which has information of a predetermined number of bits in the unit period starting from the transition timing to a reception device, the transmission device including: a transmission unit configured to transmit control data indicating a control signal for controlling the reception device and image data as the serial data to the reception device; and a transmission control unit configured to control data transmission by the transmission unit. Further, the transmission control unit causes the transmission unit to transmit the image data as a first type of data for which two or more transitions from the second level to the first level are in the unit period, and the transmission control unit causes the transmission unit to transmit the control data as a second type of data for which one transition from the second level to the first level is in the unit period and the number of bits having the second level in the unit period corresponds to the control signal.

A reception device of the present invention is a reception device for receiving serial data for which a timing of transition from a first level to a second level is in each unit period and which has information of a predetermined number of bits in the unit period starting from the transition timing from a transmission device, the reception device including: a reception unit configured to receive control data and image data as the serial data from the transmission device; and a reception control unit configured to perform control on the basis of the data received by the reception unit. Further, the reception control unit acquires the image data from the data when the serial data received by the reception unit is a first type of data for which two or more transitions from the second level to the first level are in the unit period, and the reception control unit performs control of content according to the number of bits having the second level in the data when the serial data received by the reception unit is a second type of data for which one transition from the second level to the first level is in the unit period.

In the transmission device of the present invention, preferably, the transmission control unit causes the transmission unit to transmit the control data as the second type of data in a plurality of continuous unit periods when the control data is transmitted to the reception device. In the reception device of the present invention, preferably, the reception control unit performs control of content according to the number of bits having the second level in each of a plurality of second types of data when the serial data received by the reception unit is the second type of data in a plurality of continuous unit periods.

In the transmission device of the present invention, preferably, when the image data is designated as the first type of data, the transmission control unit designates the image data as the first type of data by adding level inversion information to level-inverted data if the number of transitions from the second level to the first level in the unit period is larger for data obtained by inverting a level of a specific bit of original data than for the original data. In the reception device of the present invention, preferably, when the serial data received by the reception unit is the first type of data and level inversion information is included in the data, the image data is acquired from data obtained by inverting a level of a specific bit of the data.

A transmission/reception system of the present invention includes the transmission device of the present invention and the reception device of the present invention. An image display system of the present invention includes the transmission device of the present invention, the reception device of the present invention; and an image display device configured to display an image on the basis of the image data acquired by the reception device.

### Advantageous Effects of Invention

According to the present invention, it is possible to increase the degree of freedom of control data transmission from a transmission device to a reception device.

### BRIEF DESCRIPTION OF DRAWINGS

FIG. 1 is a diagram illustrating a schematic configuration of an image display system 1 of the present embodiment.

FIG. 2 is a diagram illustrating a configuration of a transmission/reception system 2 of the present embodiment.

FIGS. 3A, 3B and 3C are diagrams for describing data (a first type of data) and control data (a second type of data).

FIGS. 4A, 4B, 4C and 4D are diagrams for describing image data (a first type of data).

FIGS. 5A, 5B, 5C and 5D are diagrams for describing a timing of transmission/reception of each of the image data and the control data.

### DESCRIPTION OF EMBODIMENTS

Hereinafter, embodiments of the present invention will be described in detail with reference to the accompanying drawings. The same elements in the description of the drawings are assigned the same reference signs and redundant description thereof will be omitted.

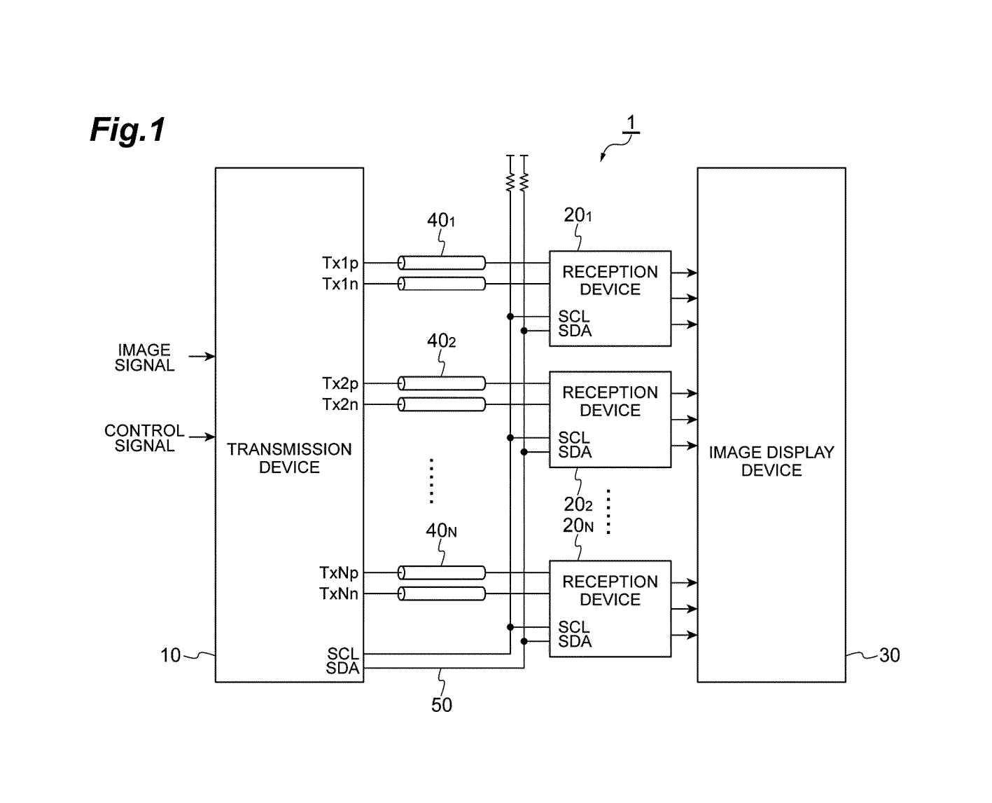

FIG. 1 is a diagram illustrating a schematic configuration of an image display system 1 of the present embodiment. The image display system 1 illustrated in FIG. 1 includes a transmission device 10, N reception devices 20₁ to 20_{N}, and an image display device 30. The transmission device 10 and the N reception devices 20₁ to 20_{N} constitute a transmission/reception system of the present embodiment. Here, N is an integer greater than or equal to 2 and n shown below is each integer greater than or equal to 1 and less than or equal to N. In FIG. 1, the illustration of a drive unit and a signal line for vertical scanning of an image in the image display device 30 is omitted.

The transmission device 10 inputs an image signal and a control signal (control command) from an outside and transmits image data and control data as serial data to each of the N reception devices 20₁ to 20_{N}. The image data is serial data generated on the basis of the image signal. The control data is serial data generated on the basis of the control signal. The serial data is data in which a clock is embedded, a timing of transition from a first level to a second level is provided in each unit period, and the serial data has information of a predetermined number of bits in the unit period starting from the timing of transition. One of the first level and the second level is a high level and the other is a low level. The transition from the first level to the second level at the starting timing of each unit period corresponds to the clock.

For example, the control signal includes a signal indicating the polarity of the image data transmitted from each reception device 20ₙ to the image display device 30, a signal indicating a start position of data writing to a register embedded in each reception device 20ₙ, a signal indicating a data header position during a blank period, and a signal indicating a frame start position. Also, the control signal also includes a training signal for each reception device 20ₙ to perform clock training.

Each reception device 20ₙ receives image data and control data arriving from the transmission device 10 through a first signal line 40ₙ. Each reception device 20ₙ performs control of content indicated by received control data. Also, each reception device 20ₙ transmits an image signal obtained by receiving the image data to the image display device 30. The image display device 30 is, for example, a liquid crystal panel, and displays an image on the basis of image signals transmitted from the reception devices 20₁ to 20_{N}.

The transmission device 10 and each reception device 20ₙ are connected by the first signal line 40ₙ. Each signal line 40ₙ transmits the serial data transmitted from the transmission device 10 to the reception device 20ₙ. Each signal line 40ₙ may be physically one line or a pair of lines for transmitting differential data.

Also, the transmission device 10 and the reception devices 20₁ to 20_{N} are connected by a second signal line 50, and can perform communication via the second signal line. This communication conforms to protocols of serial bus standards, for example, such as Inter-Integrated Circuit (I²C) and Serial Peripheral Interface (SPI). When the I²C standard is used as illustrated in FIG. 1, the second signal line 50 includes an SCL line through which a clock is transmitted and an SDA line through which data is transmitted. For example, the transmission device 10 can write data to a register embedded in each reception device 20ₙ by performing communication according to a predetermined protocol via the second signal line 50. Each reception device 20ₙ can perform an operation according to the data written to the register.

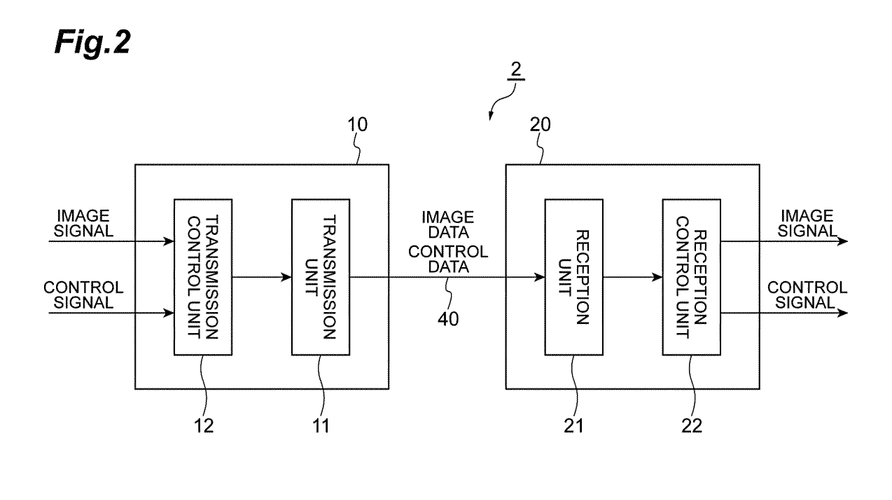

FIG. 2 is a diagram illustrating a configuration of a transmission/reception system 2 of the present embodiment. In FIG. 2, any one reception device 20 among the N reception devices 20₁ to 20_{N} is illustrated and a configuration part corresponding to the reception device 20 in the transmission device 10 is illustrated. The transmission device 10 includes a transmission unit 11 and a transmission control unit 12. The transmission unit 11 transmits control data and image data as serial data to the reception device 20. The transmission control unit 12 controls data transmission by the transmission unit 11. The reception device 20 includes a reception unit 21 and a reception control unit 22. The reception unit 21 receives the control data and the image data as the serial data from the transmission device 10. The reception control unit 22 performs control on the basis of data received by the reception unit 21.

The serial data to be transmitted from the transmission unit 11 of the transmission device 10 to the reception unit 21 of the reception device 20 are a first type of data and a second type of data. For the first type of data, two or more transitions from the second level to the first level are in the unit period. For the second type of data, one transition from the second level to the first level is in the unit period.

The transmission device 10 causes the transmission unit 11 to transmit the image data as the first type of data. At this time, the transmission control unit 12 inputs an image signal from the outside and packetizes and encodes the image data on the basis of the image signal and the transmission unit 11 serializes the encoded data and transmits the image data as the first type of data. On the other hand, when the serial data received by the reception unit 21 is the first type of data, the reception device 20 acquires the image data from the data. At this time, the reception unit 21 de-serializes the received serial data to designate the de-serialized data as parallel data and the reception control unit 22 decodes the parallel data and further unpacketizes the decoded parallel data to acquire the image data.

The transmission control unit 12 of the transmission device 10 causes the transmission unit 11 to transmit control data as the second type of data. At this time, the transmission control unit 12 inputs a control signal (control command) from the outside and the number of bits having the second level in the unit period corresponds to the control signal (control command). On the other hand, the reception control unit 22 of the reception device 20 performs control of content corresponding to the number of bits having the second level in the data when the serial data received by the reception unit 21 is the second type of data.

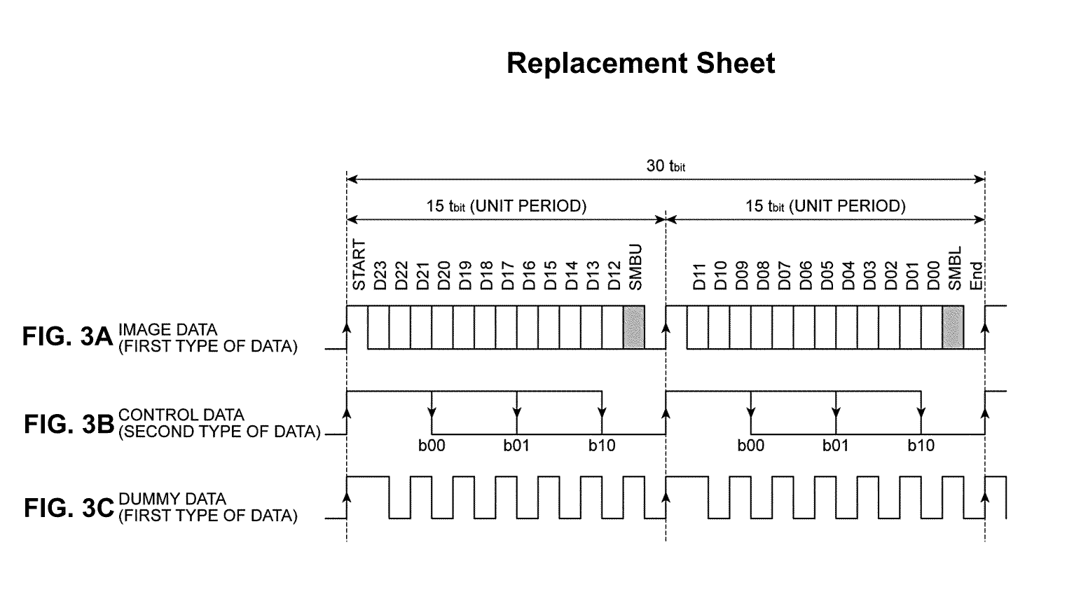

FIGS. 3A to 3C are diagrams for describing image data (a first type of data) and control data (a second type of data). In FIGS. 3A to 3C, data for the two unit periods is illustrated. Also, in FIG. 3C, dummy data (a first type of data) to be inserted during the transition from the blank period to the active period is also illustrated. The dummy data (FIG. 3(C)) is dummy data for excluding the disturbance of a data waveform during the transition from the blank period to the active period in the reception device 20.

As illustrated in FIGS. 3A to 3C, a start timing of each unit period is the timing (timing indicated by an upward arrow in FIGS. 3A to 3C) of transition from the low level (first level) to the high level (second level) in each of the image data (first type of data), the control data (second type of data), and the dummy data (first type of data). This data has 15-bit information in each unit period starting from the transition timing.

As illustrated in FIG. 3(A), image data per pixel has information of 24 bits (D23 to D00) and is represented by 30 bits for two unit periods by adding other bits thereto. The image data of each unit period includes one header bit having the high level, 12 bits (D23 to D12 or D11 to D00) indicating pixel information subsequent thereto, one bit (SMBU or SMBL) indicating predetermined information (to be described below) subsequent thereto, and one last bit having the low level. The image data to be transmitted from the transmission device 10 to the reception device 20 becomes the first type of data for which two or more transitions from the second level to the first level are in the unit period.

As illustrated in FIG. 3(B), control data of each unit period has the high level for a certain number of bits continuous from a header bit and has the low level until the last bit continuously thereafter. Thus, control data to be transmitted from the transmission device 10 to the reception device 20 becomes the second type of data for which one transition from the high level to the low level is in the unit period. Also, the control data is control data for which the number of bits having the high level in the unit period corresponds to the control signal (control command). In FIG. 3(B), the number of bits having the high level in each unit period is shown as any one of 4, 8, and 12 and it is possible to indicate three types of control signals (control commands) in each unit period.

The control data to be transmitted from the transmission device 10 to the reception device 20 may be a plurality of continuous second types of data. That is, the transmission control unit 12 of the transmission device 10 causes the transmission unit 11 to transmit the control data as the second type of data in a plurality of continuous unit periods when the control data is transmitted to the reception device 20. On the other hand, the reception control unit 22 of the reception device 20 performs control of content according to the number of bits having the high level in each of the plurality of second types of data when the serial data received by the reception unit 21 is the second type of data in a plurality of continuous unit periods. In the example illustrated in FIG. 3B, the second type of data is provided in two continuous unit periods and can indicate nine types of control signals (control commands). The control data (second types of data) may continue in three or more unit periods. When the number of continuous unit periods increases more, it is possible to transmit more various types of control signals (control commands).

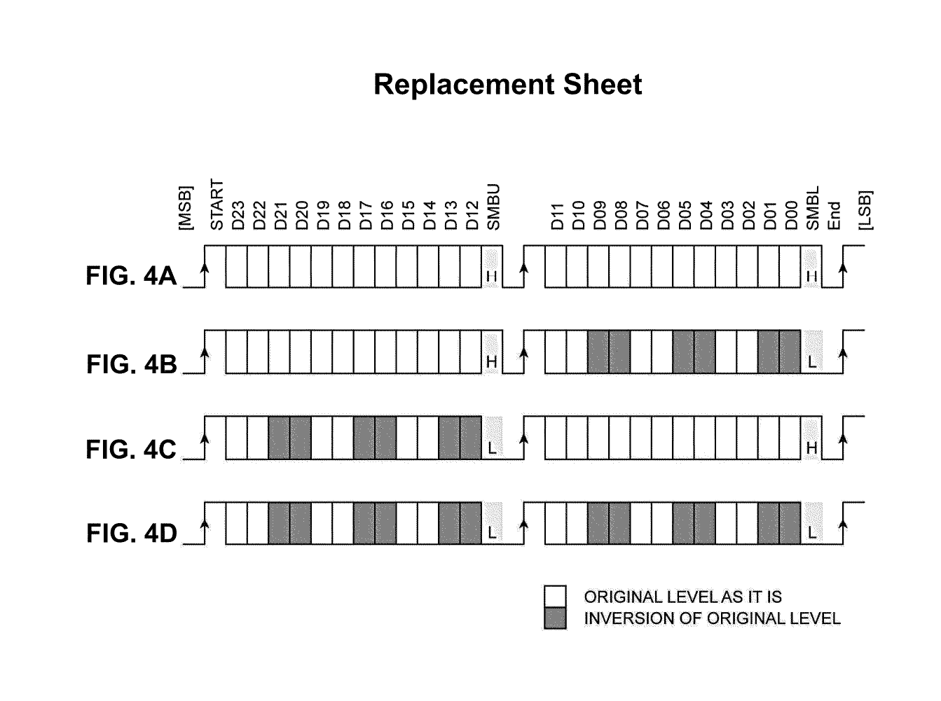

FIGS. 4A to 4D are diagrams for describing image data (a first type of data). When the image data is the first type of data, it is preferable that the transmission control unit 12 of the transmission device 10 designate the image data as the first type of data by adding level inversion information (SMBU or SMBL) to level-inverted data if the number of transitions from the second level to the first level in the unit period is larger for data obtained by inverting a level of a specific bit of original data than for the original data. At this time, when the serial data received by the reception unit is the first type of data and the level inversion information is included in the data, the reception control unit 22 of the reception device 20 acquires image data from the data obtained by inverting the level of the specific bit of the data.

In the example illustrated in FIGS. 4A to 4C, level-inverted bits among 15 bits of each unit period become a fourth bit, a fifth bit, an eighth bit, a ninth bit, a twelfth bit, and a thirteenth bit.

In FIG. 4(A), for control data to be transmitted from the transmission device 10 to the reception device 20, original data for which the number of transitions from the second level to the first level is large is selected in any of a previous-stage unit period and a subsequent-stage unit period and an SMBU or SMBL of a fourteenth bit has the high level to indicate the original data.

In FIG. 4(B), control data to be transmitted from the transmission device 10 to the reception device 20 is original data for which the number of transitions from the second level to the first level is large in a previous-stage unit period and an SMBU of a fourteenth bit has the high level to indicate the original data. On the other hand, level-inverted data for which the number of transitions from the second level to the first level is large is selected in a subsequent-stage unit period and an SMBL of a fourteenth bit has the low level to indicate the selected level-inverted data.

In FIG. 4(C), for control data to be transmitted from the transmission device 10 to the reception device 20, level-inverted data for which the number of transitions from the second level to the first level is large is selected in a previous-stage unit period and an SMBU of a fourteenth bit has the low level to indicate the selected level-inverted data. On the other hand, control data is original data for which the number of transitions from the second level to the first level is large in a subsequent-stage unit period and an SMBL of a fourteenth bit has the high level to indicate the original data.

In FIG. 4(D), for control data to be transmitted from the transmission device 10 to the reception device 20, level-inverted data for which the number of transitions from the second level to the first level is large is selected in any of a previous-stage unit period and a subsequent-stage unit period and an SMBU or SMBL of a fourteenth bit has the low level to indicate the level-inverted data.

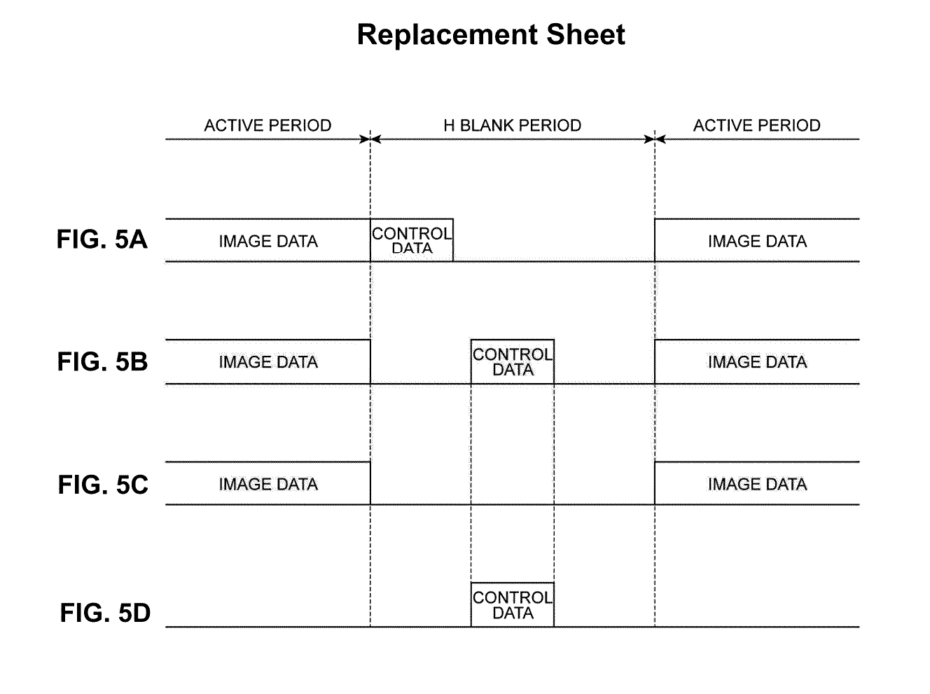

FIGS. 5A to 5C are diagrams for describing a timing of transmission/reception of each of the image data and the control data. In FIGS. 5A to 5C, an active period in which image data of a certain row is transmitted and received, an H blank period subsequent thereto, and an active period in which image data of the next row is transmitted and received are illustrated. Control data to be transmitted from the transmission device 10 to the reception device 20 may be transmitted and received immediately after the active period (during the start of the H active period) as illustrated in FIG. 5(A) and can be transmitted and received at any timing in the H active period as illustrated in FIG. 5(B).

Conventionally, the timing at which the control data is transmitted is fixed to a specific timing in the blank period as illustrated in FIG. 5(A). On the other hand, because it is possible to easily identify image data (the first type of data) and control data (the second type of data) in the reception device 20 in the present embodiment, the timing at which the control data is transmitted may be any timing in the active period as illustrated in FIG. 5(B) as well as the timing illustrated in FIG. 5(A). When the image data and the control data are transmitted at the timings of FIG. 5(B), the reception device 20 can acquire the image data from the data when the received serial data is the first type of data (FIG. 5(C)) and acquire the control data from the data when the received serial data is the second type of data (FIG. 5(D)).

Thus, in the present embodiment, the image data (first type of data) and the control data (second type of data) can be easily identified and the control data can be transmitted at any timing in the blank period. Therefore, the degree of freedom of control data transmission from the transmission device 10 to the reception device 20 is high. For example, the timing at which the reception device 20 requires the control command and the control data transmission timing can match each other and types and the number of control commands can increase.

Also, the following effects also occur due to the fact that the degree of freedom of control data transmission is increased. For example, an application for writing data to a lookup table embedded in the reception device 20 or a register such as a setting register is possible. It is possible to change content of control data for each line and dynamically change the control command. It is possible to change the timing at which the control data is inserted for each line and suppress an EMI.

### REFERENCE SIGNS LIST

1 Image display system
2 Transmission/reception system
10 Transmission device
11 Transmission unit
12 Transmission control unit
20 Reception device
21 Reception unit
22 Reception control unit
30 Image display device
40 First signal line
50 Second signal line

1. A transmission device for transmitting serial data for which a timing of transition from a first level to a second level is in each unit period and which has information of a predetermined number of bits in the unit period starting from the transition timing to a reception device, the transmission device comprising:
a transmission unit configured to transmit control data indicating a control signal for controlling the reception device and image data as the serial data to the reception device; and
a transmission control unit configured to control data transmission by the transmission unit,
wherein the transmission control unit causes the transmission unit to transmit the image data as a first type of data for which two or more transitions from the second level to the first level are in the unit period, and
wherein the transmission control unit causes the transmission unit to transmit the control data as a second type of data for which one transition from the second level to the first level is in the unit period and the number of bits having the second level in the unit period corresponds to the control signal.

2. The transmission device according to claim 1, wherein the transmission control unit causes the transmission unit to transmit the control data as the second type of data in a plurality of continuous unit periods when the control data is transmitted to the reception device.

3. The transmission device according to claim 1, wherein, when the image data is designated as the first type of data, the transmission control unit designates the image data as the first type of data by adding level inversion information to level-inverted data if the number of transitions from the second level to the first level in the unit period is larger for data obtained by inverting a level of a specific bit of original data than for the original data.

4. A reception device for receiving serial data for which a timing of transition from a first level to a second level is in each unit period and which has information of a predetermined number of bits in the unit period starting from the transition timing from a transmission device, the reception device comprising:
a reception unit configured to receive control data and image data as the serial data from the transmission device; and
a reception control unit configured to perform control on the basis of the data received by the reception unit,
wherein the reception control unit acquires the image data from the data when the serial data received by the reception unit is a first type of data for which two or more transitions from the second level to the first level are in the unit period, and
wherein the reception control unit performs control of content according to the number of bits having the second level in the data when the serial data received by the reception unit is a second type of data for which one transition from the second level to the first level is in the unit period.

5. The reception device according to claim 4, wherein the reception control unit performs control of content according to the number of bits having the second level in each of a plurality of second types of data when the serial data received by the reception unit is the second type of data in a plurality of continuous unit periods.

6. The reception device according to claim 4, wherein, when the serial data received by the reception unit is the first type of data and level inversion information is included in the data, the image data is acquired from data obtained by inverting a level of a specific bit of the data.

7. A transmission/reception system comprising:
the transmission device according to claim 1; and
the reception device,
wherein the reception device is a reception device for receiving the serial data for which the timing of transition from the first level to the second level is in each unit period and which has the information of a predetermined number of bits in the unit period starting from the transition timing from the transmission device, the reception device including:
a reception unit configured to receive control data and image data as the serial data from the transmission device; and
a reception control unit configured to perform control on the basis of the data received by the reception unit,
wherein the reception control unit acquires the image data from the data when the serial data received by the reception unit is a first type of data for which two or more transitions from the second level to the first level are in the unit period, and
wherein the reception control unit performs control of content according to the number of bits having the second level in the data when the serial data received by the reception unit is a second type of data for which one transition from the second level to the first level is in the unit period.

8. An image display system comprising:
the transmission/reception system according to claim 7; and
an image display device configured to display an image on the basis of the image data acquired by the reception device.
